(19) United States
(12) Patent Application Publication
(10) Pub. No.: US 2011/0163657 A1
(43) Pub. Date: Jul. 7, 2011

(54) PHOSPHOR, METHOD FOR PRODUCING THE SAME, AND LIGHT-EMITTING DEVICE

(75) Inventors: Yayoi Okui, Osaka (JP); Osamu Inoue, Osaka (JP); Kojiro Okuyama, Nara (JP); Seigo Shiraishi, Osaka (JP)

(73) Assignee: PANASONIC CORPORATION, Kadoma-shi, Osaka (JP)

(21) Appl. No.: 13/062,158

(22) PCT Filed: May 12, 2010
(86) PCT No.: PCT/JP2010/003222

§ 371 Date: Mar. 3, 2011

(30) Foreign Application Priority Data
May 25, 2009 (JP) 2009-125310
May 27, 2009 (JP) 2009-127560

(51) Int. Cl. H01J 63/04; H01J 1/62; C09K 11/08; C09K 11/54

(52) U.S. Cl. 313/484; 313/483; 252/301.4 R; 252/301.6 R

(57) ABSTRACT

The present invention provides a phosphor with less luminance degradation that includes an oxide that is excellent in chemical stability and allows the electrostatic charge of the phosphor surface to shift toward positive direction. The present invention is a phosphor including a phosphor body and a composite oxide on at least a part of the surface of the phosphor body. The composite oxide contains M, Sn, and O, and M is at least one element selected from the group consisting of Ca, Sr, and Ba.

### TECHNICAL FIELD

The present invention relates to a phosphor and a method for producing the phosphor. The present invention also relates to a light-emitting device, such as a plasma display panel, using the phosphor.

### BACKGROUND ART

Plasma display panels (hereinafter referred to as PDPs) have been utilized and rapidly spread, since they have features that they can achieve a large screen size easily, display images with fast response time, and be manufactured at low cost, among flat-screen display panels.

The typical structure of the PDPs that are currently utilized is as follows. Pairs of electrodes arranged regularly are provided on two glass substrates facing each other, which are designed to be a front panel side and a back panel side, respectively. Dielectric layers made of, for example, low-melting-point glass are provided so as to cover these electrodes. Phosphor layers are provided on the dielectric layer of the back substrate side, and an MgO layer is provided as a protective layer on the dielectric layer of the front substrate side in order to protect the dielectric layer from ion bombardment and release secondary electrons. A gas mainly containing an inert gas such as Ne and Xe is filled and sealed between the two substrates. A voltage is applied between the electrodes to generate a discharge, and the phosphors are allowed to emit light by an ultraviolet ray generated by the discharge. Thereby, an image is displayed.

The PDPs establish full color displays using phosphors of three primary colors (red, green and blue). These phosphors each are constituted by a plurality of elements, and the phosphors show the specific electrostatic charge properties depending on the electronegativitis of the elements contained therein, the crystal structures thereof, and the like. When the specific electrostatic charge properties of the phosphors of each color differ from each other, the quantity of a residual charge after a discharge caused by an applied voltage for display differs from the phosphor of one color to the phosphor of another color. The difference of the quantity of a residual charge causes a difference in a voltage required for a discharge from the phosphor of one color to the phosphor of another color, which results in variation in discharges and decrease of the margin of the voltage.

Typical phosphors used in the PDPs are (Y, Gd)BO₃:Eu³⁺ for a red color (R), Zn₂SiO₄:Mn²⁺ for a green color (G), and BaMgAl₁₀O₁₇:Eu²⁺ for a blue color (B). When the charge quantities are measured on these phosphors of each color (R, G, B) by a blow-off charge measuring method, which is a common charge measuring method for evaluating a triboelectric charge between powders, their charge quantities have a relation of (+) R≧B>0>G (−). In this manner, only the surface electrostatic charge of the green phosphor is negative. Accordingly, a green phosphor whose surface electrostatic charge is shifted toward positive direction is strongly demanded.

In response to this, methods of allowing phosphors of each color to have similar electrostatic charges by coating a phosphor surface have been proposed (Patent Literature 1 and Non Patent Literature 1). For example, Patent Literature 1 discloses a method in which a surface of a phosphor is coated with an oxide of an element whose electronegativity is selected depending on the electrostatic charge property of the phosphor surface. Specifically, a method in which a silicate green phosphor having a composition of Zn₂SiO₄:Mn²⁺ is coated with at least one selected from ZnO, Y₂₀₃, Al₂O₃, Bi₂O₃, and MgO is proposed, for example. Patent Literature 2 discloses a method of allowing an electrostatic charge of a surface of a green phosphor to shift toward positive direction by coating the surface of the green phosphor with a film of Al₂O₃, MgO, BaO, or the like.

### CITATION LIST

### Patent Literature

Patent Literature 1: JP2004-323576A
Patent Literature 2: JP3587661B

### Non Patent Literature

Non Patent Literature 1: Phosphor Research Society, Meeting Technical Digest, 2007, 318, p. 15-22

### SUMMARY OF INVENTION

### Technical Problem

However, it has been found through detailed studies by the present inventors that MgO and BaO that allow an electrostatic charge to shift largely toward positive direction are unstable substances that form hydroxides or carbonates by reacting with water or a carbon dioxide gas, and there arises a problem that luminance degradation is large when the above conventional phosphors are used in the state where a small amount of water remains in a panel.

The present invention has achieved a solution to the above-mentioned conventional problem, and it is an object of the present invention to provide a phosphor with less luminance degradation that includes an oxide that is excellent in chemical stability and allows the electrostatic charge of the phosphor surface to shift toward positive direction. It is a further object of the present invention to provide a long-life light-emitting device, particularly a PDP, using the phosphor.

### Solution to Problem

The present invention is a phosphor including a phosphor body and a composite oxide on at least a part of the surface of the phosphor body. The composite oxide contains M, Sn, and O, and M is at least one element selected from the group consisting of Ca, Sr, and Ba.

Another embodiment of the present invention is a light-emitting device including a phosphor layer that contains the above phosphor. A preferred example of the light-emitting device is a plasma display panel.

The plasma display panel includes, for example: a front panel; a back panel that is arranged to face the front panel; barrier ribs that define a clearance between the front panel and the back panel; a pair of electrodes that are disposed on the back panel or the front panel; an external circuit that is connected to the electrodes; a discharge gas that is present at least between the electrodes and contains xenon that generates a vacuum ultraviolet ray by applying a voltage between the electrodes through the external circuit; and phosphor layers that emit visible light induced by the vacuum ultraviolet ray, and the phosphor layer contains the above phosphor.

Yet another embodiment of the present invention is a method for producing a phosphor, including the step (1) of dissolving, into a liquid, particles of a composite oxide containing M, Sn, and O wherein M is at least one element selected from the group consisting of Ca, Sr, and Ba; the step (2) of precipitating the elements constituting the composite oxide again from the resultant solution; and the step (3) of mixing the resultant precipitate with a phosphor body and firing them.

### Advantageous Effects of Invention

According to the present invention, the phosphor with less luminance degradation in which the electrostatic charge of the surface has been shifted toward positive direction can be provided. Furthermore, a long-life light-emitting device, such as a PDP, in which the luminance is not degraded even after long-time driving can be provided.

### BRIEF DESCRIPTION OF DRAWINGS

FIG. 1 is a schematic cross-sectional view showing an example of a structure of a PDP of the present invention.

FIG. 2 shows powder X-ray diffraction spectra in the range of 2θ=24 to 27 degrees, of a phosphor of sample No. 5 as an example of the present invention and a phosphor of sample No. 9 as a comparative example.

### DESCRIPTION OF EMBODIMENTS

Hereinafter, embodiments of the present invention will be described in detail.

As the results of the detailed studies, the present inventors have found that a phosphor in which a composite oxide containing M (defined as above), Sn, and O is present on at least a part of the surface of the phosphor particles has an electrostatic charge that has been shifted toward positive direction relative to a phosphor (phosphor body) in which a composite oxide containing M (defined as above), Sn, and O is absent on the surface of the phosphor particles, and such a phosphor shows less luminance degradation. Accordingly, the present inventors have found that use of such a phosphor can achieve a light-emitting device (particularly a PDP) in which the luminance is less degraded even after long-time driving comparing to the case using a conventional phosphor.

The composite oxide containing M (defined as above), Sn, and O is a positively charged material containing Ca, Sr, or Ba that has a low electronegativity, and the composite oxide has high stability against water. Therefore, when such a composite oxide is present on a surface of a phosphor, the electrostatic charge of the phosphor surface can be shifted toward positive direction without impairing the stability of the phosphor against water.

The composite oxide used in the present invention may contain other elements, such as an element partially substituting a Ca, Sr, Ba, or Sn site and an impurity element, as long as they do not essentially impair the properties for a positively charged material and the stability against water. In the composite oxide, the total content of M (defined as above), Sn, and O is preferably 60 atom % or more, and more preferably 80 atom % or more.

In order to ensure the stability of the phosphor and allow the electrostatic charge to shift more largely toward positive direction in the present invention, a composition ratio M/Sn of M (defined as above) to Sn is preferably 0.1 to 1.5 and more preferably 0.2 to 1.2, when the composition ratio is obtained from the measurement on the surface of the phosphor of the present invention by an X-ray photoelectron spectroscopy (hereinafter referred to as an XPS).

The XPS is a surface analysis method to measure the energy of photoelectrons that have come out from a sample by irradiating the sample surface with an X-ray with a known wavelength (e.g., AlKα line, energy value: 1487 eV). Thereby, information in the area within generally about several nm from the sample surface can be obtained selectively. Hence, in the present invention, the surface of the phosphor particle means an area from the surface to several nm toward the center, which is measurable using an XPS.

In the XPS measurement, peaks corresponding to several levels for each element can be observed. It should be noted that, in some cases, the composite oxide containing M (defined as above), Sn, and O, which is present on the surface of the phosphor of the present invention, does not form a uniform layer with a thickness of several nm or more, and in this case, besides M, Sn and O, the elements constituting the phosphor itself are also detected in the XPS measurement. In this regard, for the calculation of the composition ratio, peaks which do not overlap the peaks of the constituting element of the phosphor can be used in the XPS measurement. For example, peaks of Ca2p, Sr3s, Ba3d5, and Sn3d5 are used, respectively.

In order to ensure the stability of the phosphor and allow the electrostatic charge to shift more largely toward positive direction in the present invention, it is preferable that a peak having the d value of 2.78 to 2.92 Å be present in an X-ray diffraction pattern obtained by X-ray diffraction measurement on the phosphor. This peak is derived from the above-described composite oxide. It is preferable that the peak have an intensity of 1/30 or less of the maximum peak intensity in the X-ray diffraction pattern.

For the powder X-ray diffraction measurement, BL19B2 powder X-ray diffraction equipment (Debye-Scherrer optical system using an imaging plate; hereinafter referred to as BL19 diffraction equipment) in the large-scale synchrotron radiation facility, SPring 8, or common X-ray diffractometers can be used.

When the measurement is carried out with the BL19 diffraction equipment, for example, a Lindemann glass capillary with an internal diameter of 200 μm is used and the incident X-ray wavelength is set to approximately 1.3 Å using a monochromator. While a sample is rotated with a goniometer, the diffraction intensity is recorded on the imaging plate. The measuring time is to be determined, paying attention to keep the imaging plate unsaturated. The measuring time is, for example, 5 minutes. The imaging plate is developed and an X-ray diffraction spectrum is read out.

An accurate incident X-ray wavelength is confirmed using a CeO₂ powder (SRM No. 674a) of NIST (National Institute of Standards and Technology) whose lattice constant is 5.4111 Å. The data measured on the CeO₂ powder is subjected to Rietveld analysis while varying the lattice constant (a-axis length). The actual X-ray wavelength λ is calculated based on the difference between the value a′ obtained for the predetermined X-ray wavelength λ′ and the actual value (a=5.4111 Å) from the following formula.

λ=aλ′/a′

For the Rietveld analysis, RIETAN-2000 program (Rev. 2.3.9 or later; hereinafter referred to as RIETAN) is used (see NAKAI Izumi, IZUMI Fujio, “Funmatsu X-sen kaiseki-no-jissai—Rietveld hou nyumon” (Practice of powder X-ray analysis—introduction to Rietveld method), Discussion Group of X-Ray Analysis, the Japan Society for Analytical Chemistry, Asakura Publishing, 2002, and http://homepage.mac.com/fujioizumi/).

The d value of the peak is calculated from the obtained actual X-ray wavelength and the value of 20 based on the following Bragg's condition:

2d sin θ=nλ.

The electrostatic charge of the phosphor can be controlled so as to shift toward positive direction relative to that of the phosphor body, by allowing the phosphor to include the above-described composite oxide on the surface of the phosphor body. Hence, as the phosphor body used in the present invention, a silicate green phosphor Zn₂SiO₄:Mn²⁺, which has a negative electrostatic charge on the surface thereof, is used preferably. In addition, this can be applied to a green phosphor (Y, Gd)BO₃:Tb³⁺, a blue phosphor BaMgAl₁₀O₁₇:Eu²⁺, and red phosphors (Y, Gd)BO₃:Eu³⁺, Y₂O₃:Eu³⁺, and Y(P,V)O₄:Eu³⁺ so as to control their electrostatic charges.

It should be noted that the charge quantity of the phosphor can be adjusted by the amount of the composite oxide. For example, it is possible to obtain the charge quantity of −30 μC/g or more even though a green phosphor having the charge quantity with a large negative value is used as a phosphor body. It is also possible to obtain the charge quantity of not less than 0 μC/g and not more than 30 μC/g, which is comparable to the charge quantity of the conventional red phosphor and conventional blue phosphor.

Next, a method for producing the phosphor of the present invention will be described in detail.

Step (1)

The composite oxide containing M (defined as above), Sn, and O used in the present invention can be synthesized using a common method such as a solid-phase method or a liquid-phase method. The solid-phase method is a method in which material powders (metal oxide, metal carbonate, etc.) containing the metals respectively are mixed, and the mixture is thermally treated at a certain high temperature to cause a reaction. The liquid-phase method is a method in which a solution containing the respective metals is prepared, a solid phase is precipitated therefrom and the resultant precursor of the phosphor material is thermally treated to cause a reaction.

In the step (1), the composite oxide is dissolved into a liquid that has a solvency for the composite oxide so that the solution of the composite oxide is obtained. The liquid that has the solvency is not particularly limited as long as it has a solvency for the composite oxide. Various acids (e.g., hydrochloric acid, etc.) can be used suitably.

Specifically, the operation is carried out by mixing the liquid and the composite oxide. The amount of the liquid to be used is sufficient if the composite oxide is dissolved completely. The mixing operation may be carried out at room temperature or under heating.

Step (2)

In the step (2), the elements constituting the composite oxide are precipitated again from the solution obtained in the step (1). For precipitating the elements constituting the composite oxide, an alkali (e.g., sodium hydroxide, ammonia, etc.) is preferably used. A deposition containing the elements constituting the composite oxide is obtained by adding the alkali to the solution obtained in the step (1). The amount of the alkali to be used is not particularly limited as long as the elements constituting the composite oxide are precipitated. The alkali may be added until the pH of the solution reaches to an alkali region. It should be noted that for precipitating the elements constituting the composite oxide, a compound other than the alkali may be used.

Step (3)

As the phosphor body used in the step (3), the above-described phosphor can be exemplified. The phosphor body can be synthesized using a common method such as a solid-phase method or a liquid-phase method.

In the step (3), the precipitate obtained in the step (2) is mixed with the phosphor body, and the mixture is fired.

With respect to a mixing method, for example, the phosphor body may be added to the solution in which the elements constituting the composite oxide have been precipitated in the step (2), and then the solution may be stirred. By such a mixing operation, the precipitate is allowed to attach to the surface of the phosphor body.

With respect to a mixing ratio of the phosphor body and the composite oxide components, the weight of M for the composite oxide may be 0.01 to 3% relative to the weight of the phosphor body.

Next, the phosphor body to which the precipitate has attached is filtered and dried. Then, the dried product is fired. The firing temperature may be about 600 to 900° C. Since the composite oxide can be present on the surface of the phosphor body by the thermal treatment at 600 to 900° C., which is a relatively low temperature, the phosphor body can be prevented from the thermal degradation. The firing time is preferably 1 to 4 hours. The firing atmosphere may be an air atmosphere.

As a furnace to be used for the firing, furnaces that are in general industrial use may be used. A gas furnace or an electric furnace of the batch type or continuous type such as a pusher furnace may be used.

The phosphor in which the composite oxide containing M (defined as above), Sn, and O is present on at least a part of the surface of the phosphor body can be thus obtained. The particle size distribution and flowability of the phosphor powder thus obtained can be adjusted by crushing the phosphor powder again using a ball mill, a jet mill, or the like, or classifying it, if necessary.

It should be noted that the above-described method is most suitable for the method for producing the phosphor of the present invention, but the method for producing the phosphor of the present invention is not limited thereto.

A light-emitting device with excellent luminance retaining rate can be constructed by applying the phosphor of the present invention to the light-emitting device that has a phosphor layer. Specifically, for a light-emitting device having a phosphor layer, all or part of the phosphor is replaced with the phosphor of the present invention, while a light-emitting device may be constructed according to a known method. Examples of the light-emitting device include a PDP, and a fluorescent panel. Among them, a PDP is suitable.

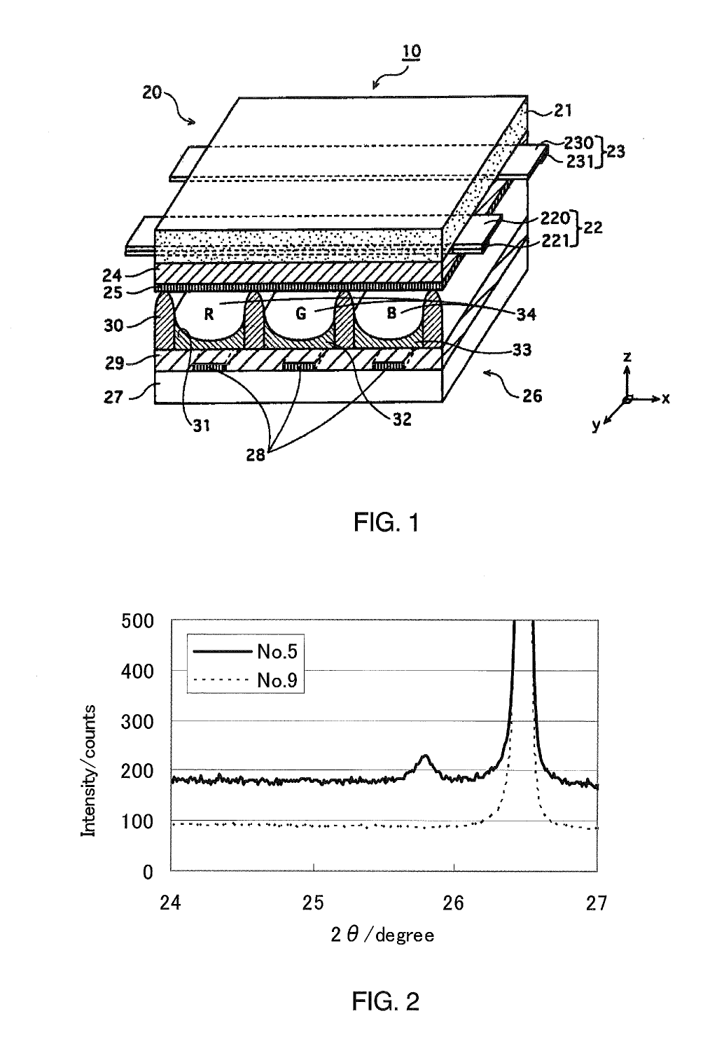

Hereinafter, an embodiment (the PDP of the present invention) in which the phosphor of the present invention is applied to a PDP will be described with an example of an AC surface-discharge type PDP. FIG. 1 is a cross-sectional perspective view showing the basic structure of an AC surface-discharge type PDP 10. It should be noted that the PDP shown here is illustrated for convenience with a size that is appropriate for a specification of 1024×768 pixels, which is the 42-inch class, and the present invention may be applied to other sizes and specifications as well.

As illustrated in FIG. 1, this PDP 10 includes a front panel 20 and a back panel 26, and these panels are arranged with their main surfaces facing each other.

The front panel 20 includes a front panel glass 21 as a front substrate, strip-shaped display electrodes (X-electrode 23, Y-electrode 22) provided on one main surface of the front panel glass 21, a front-side dielectric layer 24 having a thickness of approximately 30 μm covering the display electrodes, and a protective layer 25 having a thickness of approximately 1.0 μm provided on the front-side dielectric layer 24.

The above display electrode includes a strip-shaped transparent electrode 220 (230) having a thickness of 0.1 μm and a width of 150 μm, and a bus line 221 (231) having a thickness of 7 μm and a width of 95 μm and laid on the transparent electrode. A plurality of pairs of the display electrodes are disposed in the y-axis direction, where the x-axis direction is a longitudinal direction.

The display electrodes (X-electrode 23, Y-electrode 22) of each pair are connected electrically to a panel drive circuit (not shown) respectively in the vicinity of the ends of the width direction (y-axis direction) of the front panel glass 21. It should be noted that the Y-electrodes 22 are connected collectively to the panel drive circuit and the X-electrodes 23 each are connected independently to the panel drive circuit. When the Y-electrodes 22 and the certain X-electrodes 23 are fed using the panel drive circuit, a surface discharge (sustained discharge) is generated in the gap (approximately 80 μm) between the X-electrode 23 and the Y-electrode 22. The X-electrode 23 also can operate as a scan electrode, and in this case, a write discharge (address discharge) can be generated between the X-electrode 23 and an address electrode 28 to be described later.

The above-mentioned back panel 26 includes a back panel glass 27 as a back substrate, a plurality of address electrodes 28, a back-side dielectric layer 29, barrier ribs 30, and phosphor layers 31 to 33, each of which corresponds to one color of red (R), green (G), and blue (B). The phosphor layers 31 to 33 are provided so that they contact with the side walls of two adjacent barrier ribs 30 and with the back-side dielectric layer 29 between the adjacent barrier ribs 30, and repeatedly are disposed in sequence in the x-axis direction.

The phosphor layer contains the above-described phosphor of the present invention. In the preferred embodiment, the phosphor of the present invention is a green phosphor and contained in the green phosphor layer (G). The embodiment in which the present invention is a red phosphor and contained in the red phosphor layer (R) is possible, and the embodiment in which the present invention is a blue phosphor and contained in the blue phosphor layer (B) is also possible. It should be noted that the phosphor of the present invention may be used alone, and two or more kinds of the phosphor of the present invention may be mixed. Furthermore, the phosphor of the present invention may be mixed and used with a phosphor without the composite oxide. The phosphor layer in which the phosphor of the present invention is not used contains a common phosphor. Examples of the red phosphor include (Y, Gd)BO₃:Eu³⁺, and Y₂O₃:Eu³⁺, examples of the green phosphor include Zn₂SiO₄:Mn²⁺, and (Y, Gd)BO₃:Tb³⁺, and examples of the blue phosphor include BaMgAl₁₀O₁₇:Eu²⁺.

Each phosphor layer can be formed by applying a phosphor ink in which phosphor particles are dissolved to the barrier ribs 30 and the back-side dielectric layer 29 by a known applying method such as a meniscus method and a line jet method, and drying and firing them (e.g., at 500° C., for 10 minutes). The above-mentioned phosphor ink can be prepared, for example, by mixing 30% by mass of a phosphor having a volume average particle diameter of 2 μm, 4.5% by mass of ethyl cellulose with a weight average molecular weight of approximately 200,000, and 65.5% by mass of butyl carbitol acetate. In this regard, it is preferable that the viscosity thereof be adjusted eventually to approximately 2000 to 6000 cps (2 to 6 Pas), because the adherence of the ink to the barrier ribs 30 can be enhanced.

The address electrodes 28 are provided on the one main surface of the back panel glass 27. The back-side dielectric layer 29 is provided so as to cover the address electrodes 28. The barrier ribs 30 have a height of approximately 150 μm and a width of approximately 40 μm, and the longitudinal direction is in the y-axis direction. The barrier ribs 30 are provided on the back-side dielectric layer 29 so as to correspond to the pitch of the adjacent address electrodes 28.

Each of the address electrodes 28 has a thickness of 5 μm and a width of 60 μm. A plurality of address electrodes 28 are disposed in the x-axis direction, where the y-axis direction is a longitudinal direction. The address electrodes 28 are disposed at a certain pitch (approximately 150 μm). A plurality of address electrodes 28 each are connected independently to the above-mentioned panel drive circuit. An address discharge can be generated between a certain address electrode 28 and a certain X-electrode 23 by feeding each address electrode individually.

The front panel 20 and the back panel 26 are disposed so that the address electrode 28 and the display electrode are orthogonal to each other. The peripheral portions of both the panels 20 and 26 are bonded and sealed with a frit glass sealing portion (not shown) that serves as a sealing member.

An enclosed space between the front panel 20 and the back panel 26, which has been bonded and sealed with the frit glass sealing portion, is filled with a discharge gas composed of a rare gas such as He, Xe and Ne at a predetermined pressure (ordinarily approximately 6.7×10⁴ to 1.0×10⁵ Pa).

It should be noted that a space corresponding to a space between two adjacent barrier ribs 30 is a discharge space 34. A region where a pair of display electrodes intersect with one address electrode 28 with the discharge space 34 disposed therebetween corresponds to a cell used for displaying an image. It should be noted that in this embodiment, the cell pitch in the x-axis direction is set to approximately 300 μm and the cell pitch in the y-axis direction is set to approximately 675 μm.

When the PDP 10 is driven, an address discharge is generated by applying a pulse voltage to the certain address electrode 28 and the certain X-electrode 23 by the panel drive circuit, and after that, a sustained discharge is generated by applying a pulse between a pair of display electrodes (X-electrode 23, Y-electrode 22). The phosphors contained in the phosphor layers 31 to 33 are allowed to emit visible light using the ultraviolet ray with a short wavelength (a resonance line with a central wavelength of approximately 147 nm and a molecular beam with a central wavelength of 172 nm) thus generated. Thereby, a prescribed image can be displayed on the front panel side.

In accordance with a known method, the phosphor of the present invention can be applied to a fluorescent panel having a phosphor layer that is excited by an ultraviolet ray and then emits light. This fluorescent panel exhibits better resistance to luminance degradation compared to conventional fluorescent panels.

### EXAMPLES

Hereinafter, embodiments of the present invention will be described in detail with reference to examples. However, the present invention is not limited to these examples.

In the examples, a green phosphor Zn₂SiO₄:Mn²⁺ (hereinafter referred to as a ZSM) whose surface electrostatic charge was negative was used as a phosphor body.

As one example of the synthesis method of the phosphor body, a synthesis method by a solid-phase method will be described. As a source material, MnCO₃, ZnO, and SiO₂ each having high purity (purity of 99% or more) are used. The source materials are mixed at the mixing ratio shown below, and the mixture is fired in an atmosphere gas at 1000 to 1300° C. for 4 hours

MnCO₃: 0.10 (mol)

ZnO: 1.90 (mol)

SiO₂: 1.00 (mol)

For the mixing operation, a V-type mixer, agitator, ball mill having a crushing function, vibration mill, jet mill, and the like, which are in general industrial use, may be used.

The following production method was employed in order to allow the composite oxide containing M (defined as above), Sn, and O to be present on the surfaces of the green phosphor particles.

Samples Nos. 1, 2, and 4 to 7 were produced using MSnO₃ (M is defined as above) as a raw material. In the synthesis of MSnO₃, CaCO₃, SrCO₃, BaCO₃ and SnO₂ of special grade or higher grade were used as starting materials. These starting materials were weighed so that a molar ratio of M ions and Sn ions was 1:1, and wet-mixed using a ball mill. The mixture was dried and thus a mixed powder was obtained. The mixed powder was fired in the air in an electric furnace at 1200° C. to 1500° C. for 2 hours. A part of the obtained powder was analyzed by an X-ray diffraction method, and thereby the formation of MSnO₃ was confirmed. Next, MSnO₃ was dissolved in a hydrochloric acid solution of pH about 1, and then an aqueous NaOH solution was added thereto to precipitate a fine deposition containing M and Sn. The pH of the solution this time was 7. A non-treated ZSM (phosphor body) was introduced into the solution, and the solution was stirred to mix the non-treated ZSM and the deposition. An aqueous NaOH solution was further added, as required, to adjust the pH to 9 to 13. Thus, a precursor of the composite oxide containing M, Sn, and O was allowed to attach to the surface of the ZSM. The mixture was filtered, and the residue was dried. Thereafter, the dried product was fired in the air at 700 to 900° C. for 2 hours, and thus each of ZMSs of sample Nos. 1, 2, and 4 to 7 including a composite oxide containing M, Sn, and O on the surface thereof was obtained. The amount of the MSnO₃ used for the reaction was 0.05 to 1% in terms of the weight ratio of M to the phosphor body. The pH of the reaction solution was measured with a pH meter.

On the other hand, samples Nos. 3 and 8 for comparative examples were produced using chlorides of M and Sn as a raw material according to the following manner. MCl₂ of special grade or higher grade was dissolved in water, and a ZSM was added thereto. Na₂CO₃ was added thereto under stirring to deposit a carbonate of M. The deposition and the ZSM were mixed further under stirring in the solution so that the carbonate of M was allowed to attach to the surface of the ZMS. The mixture was filtered, and the residue was dried. The dried product was thus collected. Next, SnCl₂ of special grade or higher grade was dissolved in water, and an aqueous NaOH solution was added thereto to deposit a hydroxide of Sn. The above dried product was added thereto, and the deposition and the dried product were mixed under stirring in the solution so that the hydroxide of Sn was allowed to attach to the surface of the ZSM to which the carbonate of M had already attached. The mixture was filtered, and the residue was dried. Thereafter, the dried product was fired in the air at 800 to 1200° C., and thus ZMSs of sample Nos. 3 and 8 including an attached matter containing M and Sn were obtained. In the phosphors of sample Nos. 3 and 8, the formation of the composite oxide was not observed, as described later. The amount of MCl₂ and SnCl₂ used for the reaction were 0.05 to 0.5% in terms of the weight ratio of M to the phosphor body and 0.07 to 0.4% in terms of the weight ratio of Sn to the phosphor body, respectively.

<Measurement of Weight Gain Ratio>

The weight gain ratios of MSnO₃ (M is defined as above) used as a raw material were measured (Table 1). A part of the MSnO₃ powder was weighed and packed in the porous cell that shows no moisture absorption. The cell was allowed to stand for 12 hours in a thermo-hygrostat inside of which was an air of the temperature of 35° C. and the humidity of 60%. After that, the weight was measured again, and the weight gain ratio was measured. Thereafter, the cell was allowed to stand further for 12 hours in a thermo-hygrostat inside of which was an air of the temperature of 65° C. and the humidity of 80%. After that, the weight was measured again, and the weight gain ratio (integrated value) was calculated. The smaller the weight gain ratios are, the better chemical stability the compound has. For the comparison, the weight gain ratios of MgO powder were measured in the same manner.

<X-Ray Photoelectron Spectroscopy>

The obtained phosphors were analyzed using a XPS, and the composition ratios M/Sn of M (defined as above) to Sn in the area from the surface to several nm toward the center were calculated. For the measurement, Quantera SXM equipment manufactured by ULVAC-PHI, Inc., was used. The measurement was performed in the measurement area of 100 μm on a powder sample retained on an In foil. For the calculation of the ratio M/Sn, peaks of Ca2p, Sr3s, Ba3d5, and Sn3d5, which did not overlap the peaks of the constituting elements of the non-treated ZSM, were used as peaks derived from M and Sn. For the calculation of the composition ratio, an analysis software MultiPak was used. Each peak area was determined after the background was subtracted by Shirley's method, and then the composition ratio was calculated.

<Charge Quantity Measurement>

For the measurement of the charge quantity of the examples and comparative examples, a blow-off powder charge quantity measuring unit that can measure a triboelectric charge between powders was used. A measurement sample (phosphor) and a standard powder (carrier) to be subject to friction with the measurement sample were mixed sufficiently under stirring so that the phosphor was triboelectrically charged. The mixed sample was put into a metal vessel (Faraday cage) that was insulated from the ground. A metal net having a mesh size that is larger than the particle size of the phosphor but smaller than the particle size of the carrier was put on the vessel. The phosphor was separated and removed by sucking it with a pump from the upper side of the net. At this time, a charge Q that had a quantity equal to that the phosphor had taken away but whose sign was reversed was left in the cage. Accordingly, the charge Q was determined from a capacity C of a capacitor connected to the Faraday cage and voltage V, using the relation of Q=CV. Using the weight m of the sample powder sucked, the powder charge quantity per unit weight can be obtained as −Q/m (coulomb/gram). As the carrier powder, ferrite coated with a resin was used. The measurement sample in which the phosphor and the carrier were mixed was prepared so that 2 wt % of the phosphor was contained. The measurement sample was mixed for 3 minutes using a mixer, and was then subjected to the measurement.

TABLE 1

Weight gain ratio (wt %)

| | 35° C. 60% 12 h | +65° C. 80% 12 h |
|---|---|---|
| CaSnO₃ | 0 | 0 |
| SrSnO₃ | 0 | 0 |
| BaSnO₃ | 0.1 | 0.1 |
| MgO | 0 | 0.8 |

TABLE 2

| | | Synthesis condition | | | | | | Charge | |
|---|---|---|---|---|---|---|---|---|---|
| | | Raw | M | Sn | Reached | Firing | XPS | quantity | Ex./ |
| No. | M | material | [(g/g)%] | [(g/g)%] | pH | temp. | M/Sn | μC/g | C. Ex. |
| 1 | Ca | CaSnO₃ | 0.5 | — | 12.4 | 900 | 0.85 | −16 | Ex. |
| 2 | Sr | SrSnO₃ | 0.4 | — | 12.1 | 900 | 0.86 | −8 | Ex. |
| 3 | Ba | BaCl₂,SnCl₂ | 0.5 | 0.4 | — | 1200 | 2.46 | 6 | C. Ex. |
| 4 | Ba | BaSnO₃ | 0.3 | — | 12.5 | 700 | 0.95 | 6 | Ex. |
| 5 | Ba | BaSnO₃ | 1 | — | 12.2 | 700 | 0.79 | 35 | Ex. |
| 6 | Ba | BaSnO₃ | 0.3 | — | 9.4 | 700 | 0.61 | 0 | Ex. |
| 7 | Ba | BaSnO₃ | 0.05 | — | 11.1 | 700 | 0.21 | −29 | Ex. |
| 8 | Ba | BaCl₂,SnCl₂ | 0.05 | 0.07 | — | 800 | 0.06 | −93 | C. Ex. |
| 9 | Non- | — | — | — | — | — | — | −100 | C. Ex. |
| | treated | | | | | | | | |

Table 1 shows the results of the measurement of the weight gain ratios of MSnO₃ (M is defined as above). CaSnO₃, SrSnO₃, and BaSnO₃ showed little weight gain even under the harder condition, i.e. 65° C., 80%, 12 h, and it was confirmed that they have better stability against water than MgO. Accordingly, it can be concluded that a ZSM including MSnO₃ (M is defined as above) on the surface thereof is essentially more stable than a ZSM including MgO on the surface thereof.

Table 2 shows the synthesis conditions of the samples of examples and comparative examples, M/S ratio (M is defined as above) of the surface obtained by the XPS measurement, and charge quantity. As the synthesis condition, the kind of the raw material used in the reaction, amount thereof (weight ratio of M or S used in the reaction relative to the phosphor body), pH reached in the case of using MSnO₃ as a raw material, and firing temperature are indicated. The charge quantities of sample Nos. 1 to 7 were shifted more largely toward positive direction than that of the non-treated ZSM. Therefore, the effect by the presence of the composite oxide on the surface was confirmed. However, with respect to sample No. 8, the charge quantity was little shifted toward positive direction, and the effect was not observed. It is presumed that the reason why the effect of allowing the charge quantity to shift toward positive direction was little obtained is because the Ba/Sn ratio of the surface of sample No. 8 was 0.06, which had an extremely Sn-rich composition and contained few Ba elements.

<Powder X-Ray Analysis Measurement>

The X-ray diffraction pattern of the phosphor sample No. 5 whose charge quantity had been shifted largely toward positive direction was measured by the above-mentioned method, using BL19 diffraction equipment in the large-scale synchrotron radiation facility, SPring 8. The measurement time was 5 minutes and the wavelength was 1.3 Å. As a result, a peak having the d value of 2.913 Å and the intensity of about 1/60 of the maximum peak intensity was observed as shown in FIG. 2. For comparison, an X-ray diffraction spectrum of sample No. 9 is also shown. According to the literature, the spectrum of BaSnO₃ has a peak having the d value of 2.91 Å with the maximum intensity. Accordingly, it was confirmed that the composite oxide containing Ba, Sn, and O that was present on the surface of the phosphor of sample No. 5 was BaSnO₃. Therefore, it can be concluded that the effect of the composite oxide can be obtained when a peak having the d value of 2.913 Å is present. In the cases of the composite oxides using Ca and Sr instead of Ba, peaks having the d values of 2.79 Å and 2.85 Å respectively with the maximum intensity appear. Therefore, when a composite oxide containing M, Sn, and O attaches to the phosphor surface, a peak having the d value of 2.78 to 2.92 Å is present. Accordingly, it can be concluded that the effect of the composite oxide can be obtained when a peak having the d value of 2.78 to 2.92 Å is present. On the other hand, with respect to samples Nos. 3 and 8, no peak having the d value of the above range was observed. Therefore, it is considered that the composite oxide was not formed.

<Luminance Retaining Rate of Panel>

PDPs having the structure of FIG. 1 were manufactured according to the above-described embodiment of an AC surface-discharge type PDP, using the green phosphors of sample Nos. 3, 5 and 9, and a comparative sample including MgO on a ZSM surface. The comparative sample including MgO on a ZSM surface was prepared by the following method. MgCl₂ was dissolved in water, and a ZSM was added thereto. An alkali was added thereto under stirring so that magnesium hydroxide deposited was mixed with the ZSM so as to attach to the ZSM. The mixture was filtered and the residue was dried. The dried product was fired in the air at 600 to 800° C., and a ZSM including MgO on the surface thereof was obtained. Each manufactured panel was subjected to accelerated driving. How much the luminance value was lowered from the initial luminance value after aging equivalent to 3000 hours was measured to calculate the luminance retaining rate. The luminance is a luminance Y in the XYZ color coordinate system of International Commission on Illumination. The luminance retaining rates were 90% for the non-treated ZSM of No. 9 and 88% for the ZSM including MgO on the surface thereof. Moreover, the luminance retaining rate of No. 3 of a comparative example was 86%, which results in worse luminance degradation. In sample No. 3, the Ba/Sn ratio determined by the XPS measurement was 2.46, which was relatively high. Therefore, it is considered that the attached matter had an extremely Ba-rich composition. Alkaline-earth metals generally are very unstable, and therefore, they are converted easily into hydroxides or carbonates. Accordingly, it is considered that sample No. 3 including the Ba-rich attached matter in which no composite oxide was formed was unstable, resulting in the decrease in the luminance retaining rate. On the other hand, the luminance retaining rate of No. 5 of example was 94%, which showed an excellent resistance to degradation. Moreover, the luminance retaining rates of samples Nos. 1 and 2 were 95% and 94%, respectively, and excellent resistances to degradation were obtained similarly.

### INDUSTRIAL APPLICABILITY

The phosphor of the present invention can be used for a light-emitting device, particularly a PDP.

1. A phosphor comprising a phosphor body and a composite oxide on at least a part of the surface of the phosphor body,
wherein the composite oxide contains M, Sn, and O, and M is at least one element selected from the group consisting of Ca, Sr, and Ba.

2. The phosphor according to claim 1, wherein a composition ratio M/Sn of M (defined as above) to Sn is 0.1 to 1.5 when the composition ratio is obtained from the measurement on the surface of the phosphor by an X-ray photoelectron spectroscopy.

3. The phosphor according to claim 1, wherein a peak having the d value of 2.78 to 2.92 Å is present in an X-ray diffraction pattern obtained by X-ray diffraction measurement on the phosphor

4. The phosphor according to claim 1, wherein the phosphor body is a silicate green phosphor having a composition of Zn₂SiO₄:Mn²⁺.

5. A light-emitting device comprising a phosphor layer that contains the phosphor according to claim 1.

6. The light-emitting device according to claim 5, wherein the light-emitting device is a plasma display panel.

7. The light-emitting device according to claim 6,
wherein the plasma display panel comprises:
a front panel;
a back panel that is arranged to face the front panel;
barrier ribs that define a clearance between the front panel and the back panel;
a pair of electrodes that are disposed on the back panel or the front panel;
an external circuit that is connected to the electrodes;
a discharge gas that is present at least between the electrodes and contains xenon that generates a vacuum ultraviolet ray by applying a voltage between the electrodes through the external circuit; and
phosphor layers that emit visible light induced by the vacuum ultraviolet ray, and
the phosphor layer contains the phosphor.

8. A method for producing a phosphor, comprising:
the step (1) of dissolving, into a liquid, particles of a composite oxide containing M, Sn, and O wherein M is at least one element selected from the group consisting of Ca, Sr, and Ba;
the step (2) of precipitating the elements constituting the composite oxide again from the resultant solution; and
the step (3) of mixing the resultant precipitate with a phosphor body and firing them.

9. The method for producing a phosphor according to claim 8, wherein the particles of the composite oxide are dissolved in an acid in the step (1), and the elements constituting the composite oxide are precipitated using an alkali in the step (2).
